(19) United States
(12) Patent Application Publication
(10) Pub. No.: US 2013/0097638 A1
(43) Pub. Date: Apr. 18, 2013

(54) SYSTEM TO CARRY MULTIMEDIA DATA OVER WIRELESS ACCESS POINT

(71) Applicant: Abilis Systems Sarl, Plan-les-Ouates (CH)

(72) Inventor: Rudolf Tanner, Azmoos (CH)

(73) Assignee: ABILIS SYSTEMS SARL, Plan-les-Ouates (CH)

(21) Appl. No.: 13/692,400

(22) Filed: Dec. 3, 2012

Related U.S. Application Data
(63) Continuation of application No. PCT/EP2011/061080, filed on Jun. 30, 2011.
(60) Provisional application No. 61/360,533, filed on Jul. 1, 2010.

(51) Int. Cl. H04N 21/61; H04N 21/482

(52) U.S. Cl. CPC H04N 21/6131; H04N 21/482
USPC 725/39; 725/62

(57) ABSTRACT

This invention can re-direct the source of TV data, and shift the source from the Internet to a new set of source entities. This new entity can be a plurality of TV receivers. All TV data can be taken from a different source by adding, for example, one or multiple DVB receivers to the access point. Whenever the user requests a TV service, the data (e.g. TV program) is taken from that entity and not from the Internet. This reduces the aggregate data volume in the backhaul and the backbone network. There are new entities added to the access point from which a certain kind of data, namely TV, is obtained and forwarded to the user (consumer) with reduced bandwidth needs because of an embedded transcoder and with a local charging system.

### REFERENCE DATA

The present application is a continuation of International Patent Application PCT/EP2011/061080, which claims priority of US provisional patent application 61/360,533 of Jul. 1, 2010. The contents of these applications are hereby incorporated in their entirety.

### TECHNICAL FIELD

The present application relates to the field of multimedia reproduction, transmission and delivery systems including, among others, broadcast systems like analogue television and digital television, transmitted by traditional radio frequency broadcast, satellite signal, and cable television as well as systems in which the multimedia data are transmitted over the internet or similar.

### RELATED ART

Dongles: It is known to interface a television receiver, for example a DVB-T receiver with a computer by an USB link. Such devices, known as “Dongles”, are plugged into an USB port on a computer, laptop, mobile phone or any other computer-like device to watch TV. Here only programs can be watched which are transmitted by means of a terrestrial broadcasting system like, for example, DVB-T. There are many dongle-based products on the market from PCTV Systems, Elgato and others.

Cable connection: It is known in the art to use a device (e.g. TV, Set-Top-Box, Computer with suitable network card) connected to a cable network that carries Internet traffic or dedicated TV signals allows the user to watch TV programs. The programs may be transmitted encrypted to the home and then the user requires an appropriate decryption module, which is put into the signal path just before the video signal is shown on the screen.

Satellite: The structure described above for cable TV has been also applied to satellite television, or terrestrial digital television. A suitable device (e.g. TV, Set-Top-Box, Computer with suitable network card) is connected to a receiver that outputs TV signals allowing the user to watch TV programmes. The programs may be transmitted encrypted and decrypted as aforementioned.

There are also known systems that transmit multimedia data over a Wi-Fi network: one product on the market, for example receiving terrestrial TV signals and retransmitting them via a Wi-Fi access point to a user's laptop/computer/phone or TV, or rather using Wi-Fi to transmit a screen output of a computer to a large TV screen for viewing laptop content on a large TV screen, for example.

It is also known to control a television and a digital video recorder from anywhere using a wireless terminal on the internet, for example a mobile phone. It is also known to transport the multimedia signal from the DVR to a mobile phone using the Internet.

In wireless telecommunications, it is known to use a femtocell, consisting of a small cellular base station designed for use in a home or small business. It connects to the service provider's network via broadband (such as DSL or cable).

U.S. Pat. No. 6,970,127 and U.S. Pat. No. 7,599,691 are also related to the present invention.

### Limitation of the Related Art

The aforementioned technologies do describe how TV can be shared on different devices or how it can be transmitted from one device to another device. But they do not address and reduce the amount of data being transmitted in the backhaul and backbone of a network that carries the Internet traffic. Today it is well known that mobile devices, in particular the iPhone and other smart portable Internet terminals, have increased the amount of data traffic in the 3G wireless macro-cell network, also on the backhaul and backbone, to such an extent that operators, e.g. some operators have changed the cost structure from flat-rate to staggered-rates, in order to “punish” high capacity generating users. In some cases they have limited the bandwidth or the data volume to customers that use a femtocell/access point.

With reference to FIG. 1, the Access Point (AP) 30 is put-up in a house or flat 20 and is connected to the Radio Network Controller (RNC) directly or via Internet through the user's Internet Service Provider (ISP). The connection chain includes, for example a DOCSIS/DVB-C/DSL modem, or any other appropriate interface, not depicted. Through the femtocell or AP 30, the portable device 85 is able to connect to the Internet 99 through the transceiver 50 of the access point 30, for example a WiFi or 3G connection or any other suitable wireless connection. When the user leaves the in-house cell, then the connection to the mobile device 85 is handed-over to the nearest macro-cell, for example 22. This is the case of the portable device 83 that is located in the macrocell 22 and is connected to the NodeB 36 provided by his network operator, or by a network operator with whom routing agreements exist. In a typical situation, both access points, the AP or the NodeB (3G terminology for a base-station), are connected to the RNC, acting as concentrator. The RNC is forwarding the voice data, means circuit-switched-data, to the Mobile Switching Centre (MSC) and data packets to the Gateway GPRS Support Node (GGSN). The receiving mobile device 83 gets its data in the same way but in reversed order of elements.

In the situation represented by FIG. 1, the mobile device 85 in the femtocell or in the in-house network 20 receives multimedia data by the path represented by arrow 105 (AP, ISP, backbone (Internet), RNC, GGSN), while the device 83 in the macrocell 22 can receive multimiedia (TV) data by the path 107 that goes through the 3G network (NodeB, RNC, GGSN). In both cases the data packets go through the RNC and GGSN.

A typical access point 30, as represented in FIG. 2 contains an antenna and can connect any (mobile) 85 device with a wireless receiver and transmitter, such as computer, laptop, mobile phone, eBook, Internet tablet, iPad, to the Internet. This negates the need for a cable connection between the AP and the (mobile) device. Hence it offers freedom of roaming and mobility indoors or in the vicinity of an AP. An AP can be a stand-alone box, connected via cable employing DSL, DOCSIS or DVB-C to the Internet. Other terms for AP are eNodeB or Home NodeB, Customer Premises Equipment (CPE) or Wireless Access Points (WAP), Wireless-LAN (WLAN) or Wi-Fi or Set-Top-Box.

An access point can carry the data over the air, the air-interface, using different procedures and methodologies, which are defined in standards. Common standards are 802.11 (Wi-Fi), 802.15, 802.16 (WiMax), 3G/WCDMA/HSPA, LTE.

FIG. 2 is a block diagram of a typical AP of known type that contains a few hardware entities such as an RF module 50 with antenna and RF transceiver, several connectivity chips like the Ethernet block 40, but also, in variants, USB or HDMI interfaces, and a data processing unit 60 for the software which may incorporate the baseband processing also. But today, the baseband processing is typically incorporated into the RF transceiver entity 50. The software which runs on the Data Processing Unit (DPU) contains the protocol stack beside the AP control software. The data is transferred between the Ethernet port and the RF module through the processing unit.

A femtocell protocol stack can have the architecture depicted in FIG. 3 and is executed in the data processing unit. The Ethernet data is packeted into datagrams and converted in the protocol stack into SDU and PDUs respectively and sent through the 3G PHY over the air-interface. Note that there is no external entry point for data along the protocol stack chain but the two PHYs.

In conventional systems, when many users watch (live) TV then the whole data traffic will come from the Internet via the GGSN, RNC and AP before it goes through the air-interface to the mobile device, as shown in FIG. 1, paths 105 and 107. This increases the data traffic in the backhaul (AP-RNC) and backbone (RNC-GGSN-Internet) of the operator and, therefore, results in very large data volumes if one considers that up to 10000 femtocell access points may be connected to a concentrator (RNC). For example, assume 20% of users watch TV in the evening and that a typical MPEG2 stream corresponds to 3.5 Mbps, then the aggregate data volume is 7000 Mbps. Considering moreover that an operator may have several hundreds of concentrators, then this adds up to a massive data volume. This snow-ball effect will even exacerbate when users watch high-definition (HD) TV. There is therefore a need to reduce the data volume stemming from, for example, terrestrial or satellite TV services.

### SUMMARY DESCRIPTION OF THE INVENTION

The proposed invention describes a system that increases the value of, for example, femtocells or any other wireless access point system, to the network operator because it reduces the data traffic in the macro-cell network stemming from mobile phones/devices, as defined by the appended claims.

### BRIEF DESCRIPTION OF THE FIGURES

FIG. 1 illustrates schematically a typical 3G/3.5G/femtocell deployment scenario.

FIG. 2 is a block diagram of an access point.

FIG. 3 depicts a femtocell protocol stack.

FIG. 4 represents schematically an access point according to the aspects of the present invention.

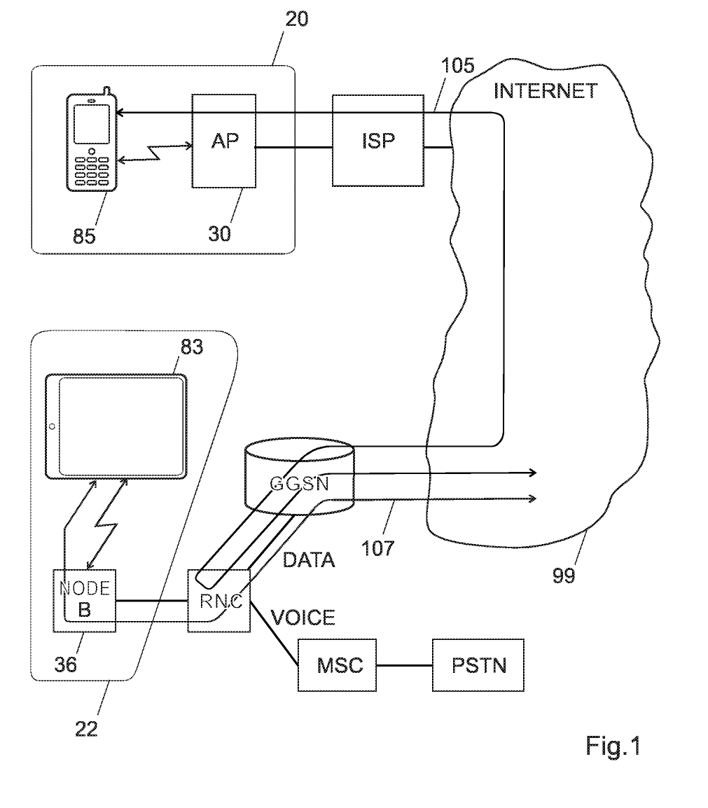

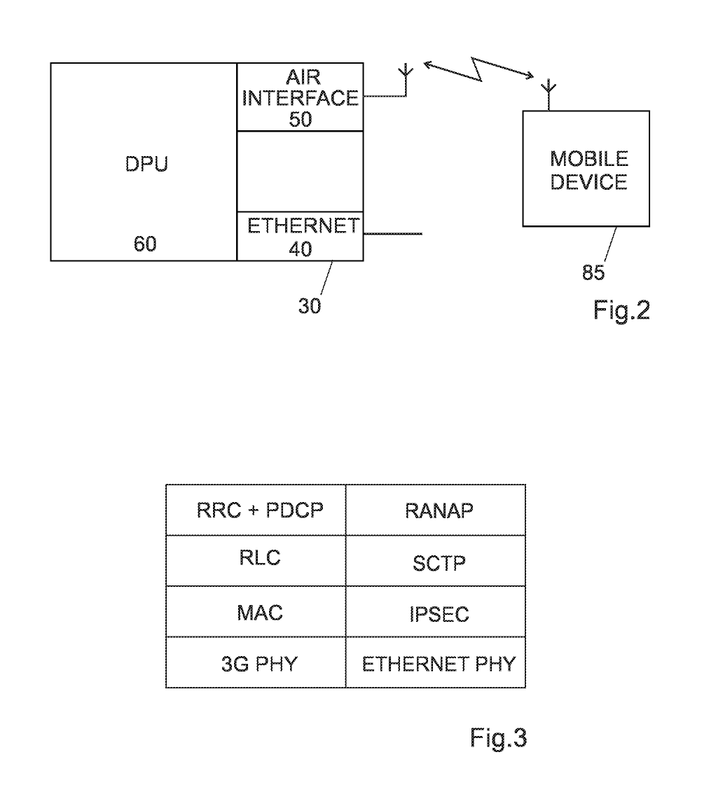

### MODES OF REALIZATION OF THE INVENTION

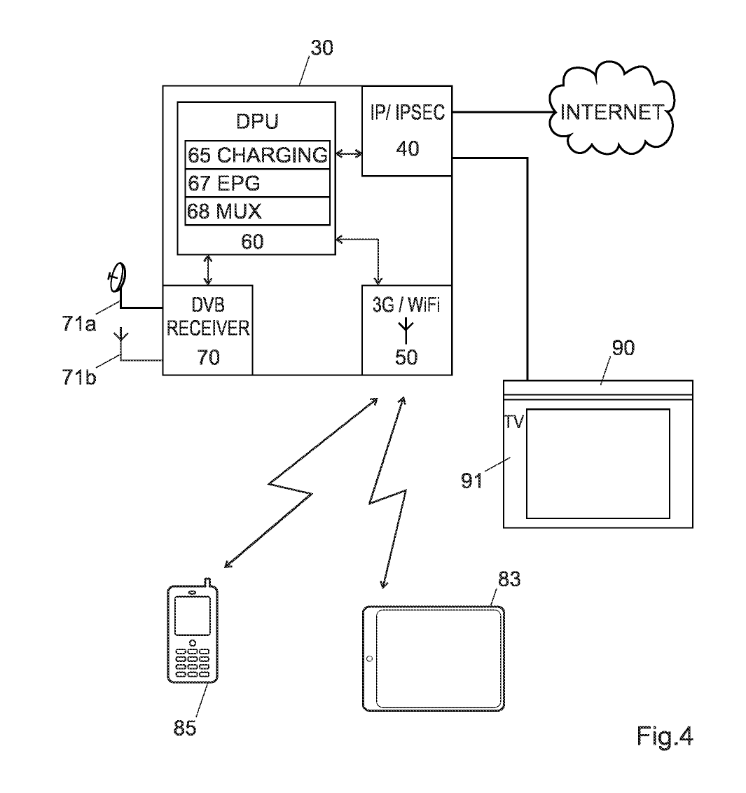

The invention proposes means to reduce the data volume, data congestion and latency, and hence reduces operator expenditures and improves user experience. As represented in FIG. 4, the access point 30 is complemented with one or multiple receivers for TV signals, for example the DVB receiver 70, which support terrestrial (e.g. DVB-T/T2/H, CMMB, DMB-T/H, ISDB, ATSC-T/M/H), satellite (e.g. DVB-S/S2/SH) or proprietary standards. The receiver is connected to suitable antennas for receiving satellite TV/radio signals, 71a and/or terrestrial TV/radio signals 71b. According to the necessity and the strength of the signal, the antennas can be integrated into the access point 30 or be located externally. If necessary, the antennas 71a and 71b could be high-gain devices optimally positioned on a roof or outside, and connected to the DVB receiver by the addition of a LNA and a suitable signal line.

A multiplexer unit (MUX) 68 is added to combine the data streams from the various receivers. In the represented schematic, the MUX unit is represented as part of the DPU 60. It could be, for example a software module arranged to combine TV signals or other multimedia data originating from either the DVB receiver 70 or the Ethernet interface 40 and routing it to the mobile devices 85, 83 connected to the access point 30 through the transceiver 50, or to the television set 95 via the Ethernet interface 40 and the set-top box 90. Alternatively, the MUX 68 could be a bespoke piece of hardware connected to the DPU 60.

Preferably the MUX 68 unit or the data processing unit contains an Electronic Program Guide (EPG) 67 entity that processes the EPG information. The EPG contains the program information and allows the user to see what programs can be watched. Preferably the EPG entity then creates or re-assembles a collated EPG from the various EPGs that can be extracted from the DVB signal obtained by the receiver 70 or from a dedicated server in the Internet or made available by service providers. Thanks to this feature, the collated EPG provides all the information that is usually offered by IP-based EPG, and includes real-time updates, inserted by the TV senders in the DVB signal.

The data processing unit contains also a mechanism allowing the network operator to charge the user watching data over the air. The 3G spectrum, for example, is not free and therefore the operator has an interest to charge for spectrum usage. The charging function is part of the core network and is implement in a module called the Policy and Charging Rules Function (PCRF) that is connected to and located close to the Mobile switching Centre (MSC) or Gateway GPRS Support NODE (GGSN).

The access point of the invention preferably includes a charging control unit 65 that is arranged to communicate with the PCRF and report the use of multimedia data from the DVB receiver 70. Since the TV data does not go through either unit, the charging control built into the AP is responsible for informing the existing charging entity PCFR that the AP is transmitting data but from a different source than the PSTN or the Internet.

The access point of the present invention is therefore capable of serving multimedia data, for example TV programs to a plurality of devices, mobiles 83, 85 or fixed 90, 91 and of receiving the multimedia data either form the internet, by the Ethernet interface 40, for example in the form of an IPTV stream, or from a broadcast radio signal, by the antennas 71a, 71b and the DVB receiver 70.

When a user selects a certain program, that is available from both the IPTV channel and from the DVB channel, the data received by the DVB receiver are preferably inserted in the protocol stack by the DPU 60 in lieu of those of the IPTV, thus limiting the use of Internet resources. The switch of data source is preferably done in a seamless and transparent way for the user. According to a variant of the invention, the switch is by a command issued on behalf of the provider of the program, for example by the GGSN or by another server in the infrastructure of the ISP. In another variant, the switch is autonomously generated by the access point 30. In another variant, the switch is determined by choice of the user, via interaction with a suitable API element on the mobile device 83, 85 or TV set 91.

Currently most TV data is transmitted as MPEG2 streams while future systems may use the MPEG4/H.264/WebM that requires less bandwidth, for example from about 3.5 Mbps to below 1 Mbps for a standard-definition TV transmission. Both formats are compatible and part of the scope of the present invention.

Preferably the access point of the present invention includes a Transcoder arranged to convert the MPEG2 stream into MPEG4/H.264/WebM stream, reducing the data rate over the air-interface further and eases the processing load on the processor in the mobile device. Advantageously, this solution allows the use of cheaper mobile devices and preserves battery life. In addition, the interference caused by the in-house cell is reduced because the indoor cell can operate at lower power. Hence one can get additional system (capacity) gain in the adjacent macro-cells and indoor cells. The modified AP, means for example a 3G/LTE femtocell, looks as follows.

The protocol stack is modified to allow for the TV data to enter the data flow from a different source than the Ethernet physical layer. Further, the functions that control the establishment and management of a transport and physical channel on the air-interface and in the Radio Network Controller RNC are modified such that the Data Processing Unit DPU informs the RNC that the user wants to watch TV. The RNC in turn tells the AP what kind of transport and physical channel to create, i.e. data rate, quality level, power and physical channel parameters. The control function executed by the RNC can be moved into the AP also, and the AP provides the RNC only with the information necessary such as for billing or network management. The RNC is aware that the data is not coming from the Gateway GPRS Support Node GGSN but from within the AP, for example from the DVB-T interface. The DPU in the AP reconfigures itself and allows the data coming from the MUX to be processed in the protocol stack and being forwarded to the RF module for over-the-air transmission. If multiple users want to watch the same TV program, then the DPU will send the same data to the other users also, maybe using a broadcasting protocol like Multimedia Broadcasting Multicast System (MBMS), and the charging unit will ensure that each user is charged correctly.

The goal of this system is to reduce the data volume and the interference which reduces expenses at the operator side (for backhaul and backbone upgrades) and increases capacity in the wireless macrocell system because of reduced interference. The user will experience faster responses because the latency is significantly reduced due to the fact that all entities are located in the AP.

1. Access point for carrying multimedia data to a plurality of wireless portable devices or wired devices over wireless access points comprising an transceiver for serving multimedia data to mobile devices and at least one TV receiver for receiving a TV broadcast signal, wherein the access point is arranged to serve multimedia data contained in the TV broadcast signal received by TV receiver to said mobile devices or to said wired devices.

2. The access point of claim 1, wherein the access points include one or multiple receivers for TV broadcast signals supporting one or several of the following protocols and standards: DVB-T/T2/H, CMMB, DMB-T/H,ISDB,ATSC-T/M/H, DVB-S/S2/SH.

3. The access point of claim 1, wherein the access point is arranged to inject the multimedia data contained in the TV broadcast signal into the protocol stack.

4. The access point of claim 1, comprising a transcoder to format the multimedia data contained in the TV broadcast signal according to MPEG2 or MPEG4/H.264/WebM.

5. The access point of claim 1, further comprising a charging unit arranged to report the use of multimedia data from the DVB receiver 70 to an external charging server.

6. The access point of claim 1, further including a EPG entity arranged to produce a Electronic Program Guide.

7. The access point of claim 6, wherein the EPG entity is arranged to produce a single Electronic Program Guide from a plurality of Electronic Program Guides.

8. The access point of claim 1, wherein the access point is arranged to transcode MPEG2 to MPEG4/H264/WebM.

9. The access point of claim 1, arranged so as to switch from a multimedia data available on the Internet to the multimedia data contained in the TV broadcast signal upon a command issued on behalf of the provider of the program by an external server.

10. Access point for carrying multimedia data to a plurality of wireless portable devices or wired devices over wireless access points comprising an transceiver for serving multimedia data to mobile devices and at least one TV receiver for receiving a TV broadcast signal, wherein the access point is arranged to serve multimedia data contained in the TV broadcast signal received by TV receiver to said mobile devices or to said wired devices wherein the access point is arranged so as to detect autonomously when multimedia data available on the Internet is also available in a received TV broadcast signal and to switch from multimedia data available on the Internet to the same multimedia data contained in the received TV broadcast signal, so as to limit the use of internet resources.
